(19) United States
(12) Patent Application Publication
(10) Pub. No.: US 2004/0108164 A1
(43) Pub. Date: Jun. 10, 2004

(54) Ladder tray with width guide and support members

(76) Inventors: Richard Franklin Pruett, Rutherfordton, NC (US); Johnny Washington Quinton, Rutherfordton, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/315,390

(22) Filed: Dec. 10, 2002

(51) Int. Cl. E06C 5/32

(52) U.S. Cl. 182/129

(57) ABSTRACT

There is provided a ladder tray for supporting tools or materials on a ladder that includes a receptacle defined by a bottom surface, a first transverse side, a second transverse side, a first longitudinal side, and a second longitudinal side in which the four sides extend upward from the bottom surface. The first transverse side includes a support member for mounting onto a step or horizontal surface of a ladder, such as a step ladder or an extension ladder. The first transverse side also includes a width guide for engaging the uprights of the ladder to prevent longitudinal and transverse motion of the mounted ladder tray. The ladder tray also includes an opening through the first transverse side for receiving a protrusion from a ladder. Flanges may be included on the longitudinal sides which define orifices for supporting tools and materials, and dividers may be included within the receptacle to define compartments within the receptacle. A second support member may also be provided on the second transverse side of the ladder tray.

### FIELD OF THE INVENTION

The present invention relates generally to ladder-mounted receptacles that support tools, paint, hardware, and the like and provide convenient access to such devices to a user on a ladder. Specifically, the invention relates to a ladder tray that provides a width guide and support members for mounting to a variety of ladder designs and sizes.

### BACKGROUND OF THE INVENTION

Ladder-mounted receptacles suitable for holding tools, paint, or hardware have existed in various configurations. These ladder trays or ladder caddies typically utilize a support member that permits temporary attachment of the tray or caddy to a step ladder or an extension ladder. A common problem associated with trays mounted to ladders is that such trays are specifically designed to attach to a single type of ladder. Furthermore, these ladder supported holding trays often only permit attachment to a specific configuration of step ladder or a specific configuration of extension ladder. As many variations of ladders exist in the marketplace there can be difficulty in finding a proper ladder tray that the ladder will accommodate.

A ladder supported holding tray is disclosed in U.S. Pat. No. 6,089,351 to Ahl et al., wherein a ladder with step engagement means located under the tray is provided for attaching the ladder tray to either a step ladder or an extension ladder. The horizontal step of a ladder is placed in an opening between the bottom panel of the tray and a step engagement means such that the tray is supported by the step and the engagement means prevents the tray from rotating or coming loose. However, such a ladder tray restricts the user from ascending up the ladder beyond the ladder tray because the ladder tray covers the step to which it is attached and it protrudes outward toward the user. In addition, the disclosed ladder tray does not restrict side-to-side, or transverse, movement of the attached ladder tray; therefore, the ladder tray could be disconnected or dislocated by an accidental strike to the side of the ladder tray.

A ladder tray that restricts transverse movement in the mounted position is disclosed in U.S. Pat. No. 4,706,918 to Wilson, wherein a side receptacle is provided on the ladder tray which creates a gap between the ladder tray and the side receptacle for receiving an upright of a ladder. The step of the ladder supports the ladder tray, and the step is positioned between an inner receptacle and an outer receptacle. The two receptacles are configured to receive a step of either a step ladder or an extension ladder. However, this ladder tray also does not allow the user to ascend up the ladder beyond the tray because it covers the step it rests upon and the outer receptacle protrudes outward toward the user.

A need exists for a ladder tray that can be attached to step ladders or extension ladders of various sizes and upon a variety of surfaces and that would limit transverse movement without obstructing the user from ascending the ladder beyond the step the ladder tray is mounted.

### BRIEF SUMMARY OF THE INVENTION

The invention addresses the above needs and achieves other advantages by providing a ladder tray for supporting tools or materials on a ladder that includes width guides for limiting transverse movement. In one embodiment of the invention, the ladder tray comprises a receptacle defining a bottom surface, a first transverse side, a second transverse side, a first longitudinal side, and a second longitudinal side. Each of the sides extends upward from the bottom surface. The first transverse side extends upward from a lower end connected to the bottom surface and terminates at an upper end of the first transverse side. The first transverse side includes a first support member proximate the upper end of the first transverse side. The first support member extends outward and includes a hook feature. The first transverse side further includes a width guide proximate the lower end of the first transverse side, and the width guide extends outward in a direction generally parallel to the first support member. The width guide is designed to engage at least one upright of a ladder to restrict transverse motion of the ladder tray.

In another embodiment of the invention, the width guide of the ladder tray includes two stepped portions that define a gap between the stepped portions. The stepped portions include transverse edges and longitudinal edges on each of the two stepped portions. At least one transverse edge is designed to engage an upright of a ladder to resist longitudinal motion of the ladder tray, and at least one longitudinal edge is designed to engage an upright of the ladder to resist transverse motion of the ladder tray. The gap between the stepped portions allows the first transverse side of the receptacle to engage an upright of some ladders to resist longitudinal motion of the ladder tray, and at least one longitudinal edge of the stepped portions engages an upright of the ladder to resist transverse motion of the ladder tray.

The ladder tray may also include at least one opening in the upper end of the first transverse side for receiving a protrusion from a ladder. A second support member may also be included and extend outward from an upper end of the second transverse side and include a hook feature. Longitudinal flanges may be included on the longitudinal sides to provide orifices for supporting tools or materials. The receptacle may also be separated into compartments with dividers that extend longitudinally from the first transverse side to the second transverse side.

In another embodiment, the ladder tray for supporting tools or materials on a ladder comprises a receptacle defining a bottom surface, a first transverse side, a second transverse side, a first longitudinal side, and a second longitudinal side. Each of the sides extends upward from the bottom surface, and the first transverse side extends upward from a lower end connected to the bottom surface and terminates at an upper end of the first transverse side. The first transverse side defines at least one opening through the first transverse side proximate the upper end of the first transverse side for receiving at least one protrusion of the ladder. The first transverse side further includes a width guide proximate the lower end of the first transverse side. The width guide is designed to engage an upright of a ladder to restrict transverse motion of the ladder tray.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a front perspective view of a ladder tray in accordance with one embodiment of the present invention;

FIG. 2 is a rear perspective view of a ladder tray of FIG. 1;

FIG. 3 is a top plan view of the ladder tray as viewed along the line 3-3 of FIG. 1;

FIG. 4 is a longitudinal cross-sectional view of the ladder tray as viewed along the line 4-4 of FIG. 2;

FIG. 5 is a vertical cross-sectional view of the ladder tray along the line 5-5 of FIG. 3 illustrating one of the smaller compartments of the receptacle and showing the ladder tray mounted to a step ladder shown in phantom lines;

FIG. 6 is a vertical cross-sectional view of the ladder tray taken along the line 6-6 of FIG. 3, and illustrating the larger compartment of the receptacle and shown mounted at two different positions on a step ladder shown in phantom lines;

FIG. 7 is a partial horizontal cross-sectional view of the ladder tray taken along the line 7-7 of FIG. 6 further illustrating the mounting features of the ladder tray;

FIG. 8 is a vertical cross-sectional view of the ladder tray similar to FIG. 6 and illustrating another position for mounting the ladder tray on a step ladder shown in phantom lines;

FIG. 9 is a vertical cross-sectional view of the ladder tray also similar to FIG. 6 and illustrating the ladder tray mounted to the inner section of an extension ladder shown in phantom lines;

FIG. 10 is a perspective view of the ladder tray mounted to the inner section of an extension ladder while the extension ladder is being raised; and

FIG. 11 is a perspective view of the ladder tray mounted to a top platform of a step ladder wherein the receptacle contains a variety of tools and items.

### DETAILED DESCRIPTION OF THE INVENTION

The present inventions will now be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

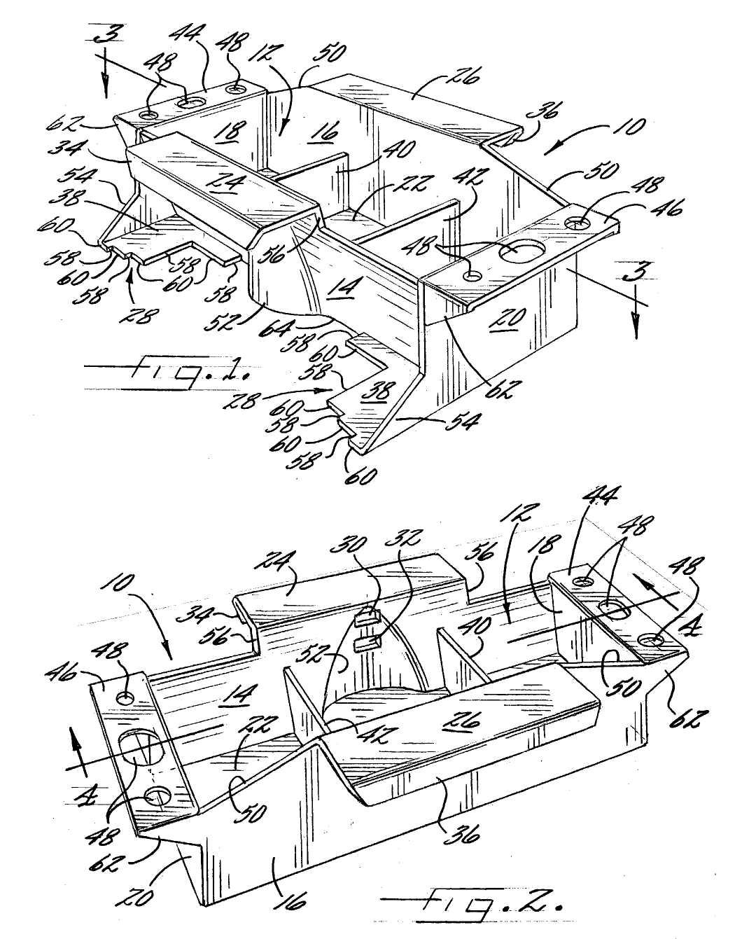

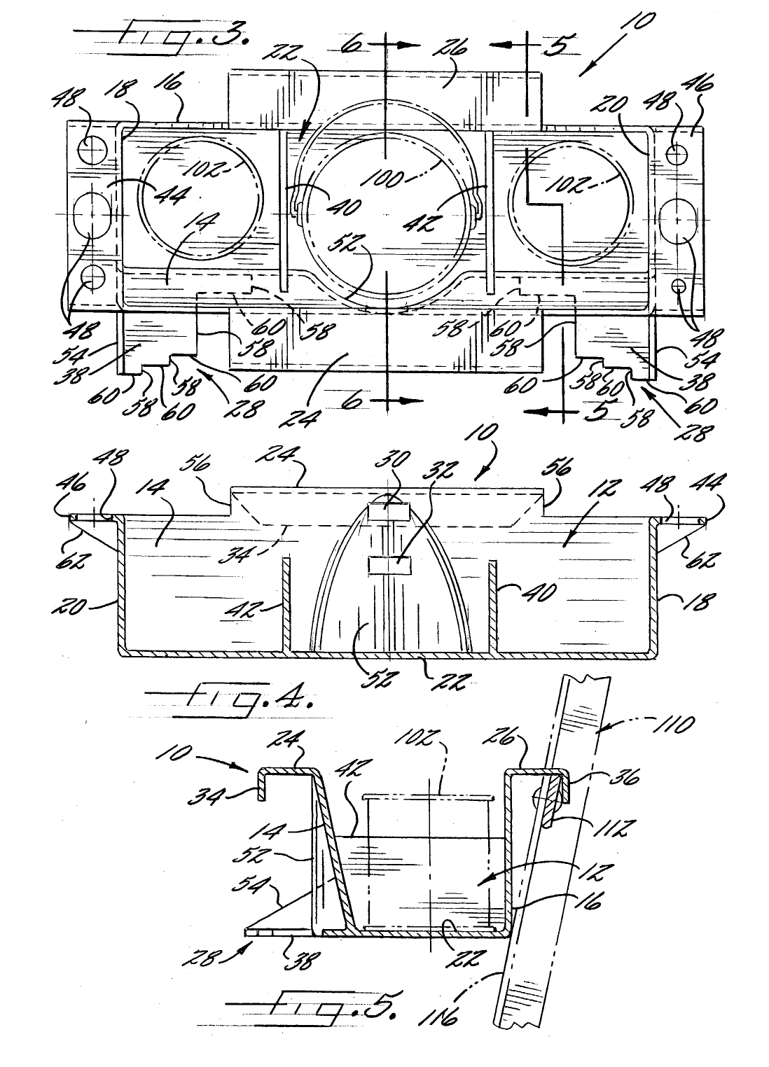

FIG. 1 illustrates a ladder tray 10 in a preferred embodiment of the present invention. Ladder tray 10 is structured and arranged to be mounted on a variety of ladders, including step ladders and extension ladders, in a variety of locations on those ladders. Ladder tray 10 has a bottom surface 22 from which first transverse side 14, second transverse side 16, first longitudinal side 18, and second longitudinal side 20 project upwards creating a receptacle 12. The four sides 14, 16, 18, and 20 are all connected to the bottom surface 22, and such connection may consist of any fasteners, adhesives, thermoplastic forming, or the like. The longitudinal sides 18 and 20 are preferably parallel to each other and perpendicular to transverse sides 14 and 16, however, the sides may be oriented in any fashion and need not constitute straight edges, non-limiting examples include curved or stepped longitudinal sides. Receptacle 12 is preferably used to hold paint, paint buckets, tools, hardware, and other accessories a user may need convenient access to while working on a ladder. FIG. 3 is a top view of ladder tray 10 in a preferred embodiment wherein the receptacle 112 can hold a one-gallon paint container 100 and two separate quart-sized paint containers 102. Dividers 40 and 42 may also be incorporated into receptacle 12 to create separate and discrete compartments within receptacle 12. Dividers 40 and 42 are preferably straight walls that protrude upward from bottom surface 22 and extend from first transverse side 14 to second transverse side 16 and run parallel to the first longitudinal side 18 and second longitudinal side 20. Dividers 40 and 42 need not extend upward as far as the longitudinal sides 18 and 20 or transverse sides 14 and 16 to separate the receptacle 12 into discrete compartments. In additional embodiments of the present invention, receptacle 12 can be separated into discrete compartments by any configuration of dividers.

Each of the four sides 14, 16, 18, and 20 of the ladder tray 10 define a lower end proximate said bottom surface 22 and an upper end at the top of each side where each of the four sides terminate at the portion of each side furthest from the bottom surface 22. Each of the four sides 14, 16, 18, and 20 also define an inner surface that generally faces in the direction of the bottom surface 22, thus facing into the receptacle 12, and an outer surface that faces outside the receptacle 12. In one embodiment, second transverse side 16, first longitudinal side 18, and second longitudinal side 20 are all preferably oriented perpendicular to the bottom surface 22 while first transverse side 14 is preferably oriented at an obtuse angle to the bottom surface 22 such that the first transverse side 14 extends outward or away from the bottom surface as the first transverse side 14 extends from the lower end proximate the bottom surface 22 to the upper end. Therefore, a preferred embodiment of the ladder tray 10 includes trapezoid-shaped first longitudinal side 18 and second longitudinal side 20 in that the horizontal edges, the lower end and upper end of each side 18 and 20, are generally parallel to each other, while the generally vertical edges, the edges contacting the transverse sides 14 and 16, tend to diverge as they proceed from the lower end to the upper end. An angled first transverse side 14 preferably provides clearance for the uprights of a ladder so that the ladder tray 10 can be mounted relatively level to the surface on the ladder to which it is mounted. Other embodiments may include differing orientations of the respective sides.

A first support member 24 includes a first transverse side 14 at the upper end of the outside surface of first transverse side 14, such that first support member 24 is proximate the top of ladder tray 10 and extends away from the receptacle 12. First support member 24 extends generally parallel to bottom surface 22. First support member 24 includes a first hook feature 34 proximate the distal edge (the edge of first support member 24 furthest from the first transverse side 14) that preferably defines a downward facing lip or flange that runs parallel to the first transverse side 14. Other embodiments of the present invention may include a first hook feature 34 that extends in other directions. The first support member 24 is designed to rest upon a step of a step ladder, a rung of an extension ladder, a top platform of a step ladder, a horizontal bar on a step ladder, or any other generally horizontally arranged surface on any type of ladder. First hook feature 34 is preferably designed to grip an edge of the horizontal surface on which the first support member 24 is supported to prevent the ladder tray 10 from becoming disengaged from the step or other generally horizontal surface of the supporting ladder. First support member 24 preferably includes a neck portion 56 that joins the first support member 24 to the upper end of first transverse side 14 and elevates the first support member 24 above the upper end of first transverse side 14. However, in other embodiments the neck portion 56 may not be present or first support member 24 may be located anywhere between the upper end and the lower end of the first transverse side 14.

Once the ladder tray 10 is mounted to a ladder by resting first support member 24 on a ladder surface, the ladder tray 10 would tend to rotate downward about the surface first support member 24 was mounted on because the weight of the ladder tray 10 and any products contained within the receptacle 12 would be cantilevered away from the ladder. Therefore, a width guide 28 is included on the outer surface of first transverse side 14, preferably proximate the lower end of first transverse side 14, to engage the uprights of the ladder and prevent rotation of the ladder tray 10. The width guide 28 is preferably included in the lower end of first transverse side 14 by a guide flange 38 which extends generally parallel to bottom surface 22 and generally parallel to first support member 24 in an outward direction. The width guide 28 preferably includes two stepped portions that are separated by a gap 64 and that are each proximate a longitudinal side 18 or 20. For structural support, the guide flange 38 and width guide 28 are supported by an angled guide support 54 which is preferably a gusset that initiates at a point below the upper end of first transverse side 14 and angles outward until terminating at the distal end of the width guide 28. In a preferred embodiment in which the first transverse side 14 angles outward as it extends upwards from the bottom surface 22 the angled guide support 54 generally defines an edge that initiates from the intersection of the upper ends of the first transverse side 14 and a longitudinal side 18 or 20 and extends downward perpendicular to the bottom surface 22. The edge remains generally vertical until the edge is approximately half the distance to the bottom surface 22. From that point the angled guide support 54 extends outward to the distal end of the width guide 28 and terminates at the width guide 28. Another embodiment of the invention may include an angled guide support 54 that forms an isosceles triangle, wherein the outer edge extending from the upper end of the first transverse side 14 to the distal end of width guide 28 is equal in length to the distance from the upper end of the first transverse side 14 to the lower end of the first transverse side 14. Other embodiments may have different configuration of angled guide support 54 or no guide support at all.

Angled guide support 54 is preferably located at the end of first transverse side 14 where first transverse side 14 intersects with a longitudinal side 18 or 20, such that angled guide support 54 generally defines an extension of the longitudinal side 18 or 20 that the angled guide support 54 is proximate. In other embodiments the angled guide support 54 and width guide 28 may be located at any position along first transverse side 14 relative to the longitudinal sides 18 or 20. The furthest point of angled guide support 54, with respect to the center of the ladder tray 10, preferably corresponds with the furthest extent of width guide 28. Width guide 28 preferably defines a series of transverse edges 60 and longitudinal edges 58 that extend generally parallel and perpendicular, respectively, to first transverse edge 14. Angled guide support 54 preferably terminates at the furthest transverse edge 60 of the width guide 28. As the width guide 28 extends inward, with respect to the center of first transverse side 14, the width guide 28 defines a stepped portion of transverse edges 60 and longitudinal edges 58. The lengths and depths of the transverse edges 60 and longitudinal edges 58, respectively, are designed to correspond with dimensions of various ladders to which the ladder tray 10 could be attached. A preferred embodiment illustrated in FIG. 1 and FIG. 3, includes two stepped portions that each include four steps, a step being defined by a transverse edge 60 and a longitudinal edge 58. However, other embodiments of the present invention may incorporate any number of steps to accommodate any number of ladders. In addition, the steps are not required to consist of transverse edges 60 and longitudinal edges 58 and may define any configuration required.

In a preferred embodiment illustrated in FIG. 1, the stepped portions of width guide 28 are each located an equal distance from the middle of first transverse side 14 and define a gap 64 between the two stepped portions of width guide 28. Other embodiments may provide for the stepped portions of width guide 28 to be located at unequal distances from the middle of first transverse side 14 such that they would not mirror each other as they do in a preferred embodiment, or there may be included three or more stepped portions of width guide 28.

Once the first support member 24 is rested upon a surface of a ladder and the first hook feature 34 engages a surface on the ladder such that the ladder tray 10 will not freely slide in a direction perpendicular to the first transverse side 14, the width guide 28 preferably contacts the uprights of the ladder below the surface of the ladder to which the first support member 24 was mounted. In this manner, ladder tray 10 is firmly mounted to the ladder. The steps of the width guide 28 preferably engage the uprights of the ladder in such a way that a transverse edge 60 contacts a surface of the upright facing towards the ladder tray 10 while the longitudinal edge 58 preferably contacts a surface of the upright facing away from the center of the ladder and perpendicular to the surface facing towards the ladder tray 10. In this preferred configuration, the transverse edge 60 prevents the ladder tray 10 from rotating or moving towards the ladder while longitudinal edge 58 prevents the ladder tray 10 from moving side-to-side, or transversely, with respect to the ladder. Because each of the two stepped portions of the width guide 28 preferably engage the ladder uprights equally, the ladder tray 10 is restricted from rotating about its center axis and from transverse motion in either directions. Other embodiments of the present invention that incorporate any width guide 28 that engages the ladder surface and uprights to restrict the movement of ladder tray 10 with respect to the ladder are within the spirit and scope of the present invention. A non-limiting example of such an embodiment being the incorporation of the transverse edges 60 and longitudinal edges 58 into first transverse side 14 so that the first transverse side 14 defines width guide 28.

The ladder tray 10 of the present invention also includes a second support member 26, as illustrated in FIG. 2. The second support member 26 is provided because of the variety of ladder types and sizes with which the present invention is intended to be used. Second support member 26 is included on the upper end of the outer surface of the second transverse side 16. In a preferred embodiment of the present invention, no neck portion analogous to the neck portion 56 of first support member 24 is provided; rather the second support member 26 is preferably located in the middle of second transverse side 16 between the upper ends of the inclined top surfaces 50 of second transverse side 16. Each inclined top surface 50 extends upward from the interface between second transverse side 16 and each longitudinal side 18 and 20 toward the center of second transverse side 16 to the edge of the second support member 26. The two inclined top surfaces 50 generally constitute an upper extension of second transverse side 16 as the three components constitute one continuous surface. However, other embodiments of the present invention may not incorporate inclined top surfaces 50, may add a neck portion, may use no neck portion, or may use any variety of configurations to mount the second support member 26 to second transverse side 16.

Second support member 26 extends outward and is generally parallel to the bottom surface 22. Second support member 26 includes a second hook feature 36 proximate the distal edge (the edge of second support member 26 furthest from the second transverse side 16) which preferably defines a downward facing lip or flange that runs parallel to the second transverse side 16. The second support member 26 is preferably intended to be used on the horizontal bars of a step ladder opposite the steps of the step ladder, but may also be rested upon a step of a step ladder, a rung of an extension ladder, a top platform of a step ladder, or any other generally horizontally arranged surface on any type of ladder. Second hook feature 36 is preferably designed to grip the edge of the horizontal surface on which the second support member 26 is supported to prevent the ladder tray 10 from becoming disengaged from the step or other generally horizontal surface of the supporting ladder. A preferred configuration of both the first support member 24 and second support member 26 is for each support member to be one continuous flange and hook; however, other embodiments of the present invention may divide one or both of the support members into two or more components or incorporate a different support configuration.

FIG. 5 illustrates the ladder tray 10 connected to a step ladder 110 using the second support member 26. Ladder tray 10 is attached to a horizontal bar 112 that is positioned between the uprights 116 on the side of step ladder 110 opposite the side the user ascends, as illustrated with uprights 118. Second support member 26 is structured and arranged to be positioned on the top surface of horizontal bar 112 and second hook feature 36 also contacts the horizontal bar 112 to prevent the ladder tray 10 from rotating off the horizontal bar 112. The uprights 116 engage the outer surface of the second transverse side 16 such that the ladder tray 10 is further prevented from rotating off the horizontal bar 112.

In a preferred embodiment of the ladder tray 10, as illustrated in FIG. 5, the second transverse side is intended to rest directly on the uprights 116 of the ladder 110 without a width guide to restrict transverse motion of the ladder tray 10 with respect to the ladder 110. However, a width guide similar to the width guide 28 on first transverse side 14 can be incorporated onto the second transverse side 16 to limit transverse movement. The second support member 26 rests upon a horizontal surface of a ladder and the outer surface of the second transverse side 16 engages the uprights of the ladder to fully mount the ladder tray and to prevent the ladder tray 10 from rotating off.

The ladder tray 10 also includes flanges for supporting brushes, tools, or the like, as illustrated in FIG. 1 and FIG. 2. A first longitudinal flange 44 is included on the upper end of first longitudinal side 18 and second longitudinal flange 46 is included on the upper end of second longitudinal side 20. Each flange 44 and 46 extends outward away from receptacle 12 and extends generally parallel to the bottom surface 22. As shown in FIG. 3, the flanges 44 and 46 contain orifices 48 of various shape or diameter to hold a variety of brushes, tools, or the like. Any configuration of holes, grooves, lips, or the like may be included on flanges 44 and 46. The geometry of the flanges 44 and 46 may also vary from a preferred rectangle to any pattern included rounded edges, angled portions, stepped portions, or the like. To increase the rigidity of flanges 44 and 46, gussets 62 are preferably included and extend upward from the outer surface of the respective longitudinal sides 18 and 20. Each flange 44 or 46 preferably includes two gussets 62, with one on each end of a flange 44 or 46 proximate the transverse sides 14 and 16. The gussets 62 can extend downward from the flanges 44 or 46 to any point between proximate the upper end of the transverse side 14 or 16 and proximate the lower end of the transverse side 14 or 16. Other embodiments may include any number, location, or pattern of gussets 62 to strengthen or decorate flanges 44 or 46.

First transverse side 14 preferably includes a first opening 30, as illustrated in FIG. 2 and FIG. 4, to allow for the passage of paint can holder tabs that may be incorporated on ladders. The opening 30 is generally a through hole located on the first transverse side 14 midway between the longitudinal sides 18 and 20 and proximate the upper end of first transverse side 14. The first opening 30 may constitute any geometric pattern necessary to allow a paint can holder tab or any other protrusion of a ladder to pass through the first opening 30. In a preferred embodiment, the top inside surface of the first opening 30 rests upon the paint can holder tab of a ladder when the ladder tray 10 is mounted on the ladder to provide additional support for the ladder tray 10 by complimenting the support provided by the first support member 24. The location, size, or shape of the first opening 30 may vary in other embodiments of the present invention as required for the ladder tray 10 to be compatible with various ladders.

Paint can holder tabs of ladders are generally located on the top platform of a ladder; therefore, the first opening 30 is most commonly utilized when the ladder tray 10 is attached to the top platform of a ladder. FIG. 8 illustrates a inwardly projecting paint can holder tab 124 located on the inside surface of the top platform 120 of a step ladder 110. In this embodiment the ladder tray 10 is mounted such that the first support member 24 is positioned below the top platform of the step ladder such that the first support member 24 does not support the load, rather the first opening 30 provides vertical support for the ladder tray 10 while the width guide 28 engages the ladder uprights to primarily provide horizontal support. However, the first opening 30 may also be used when the ladder tray 10 is mounted on any surface of the ladder that includes a protrusion.

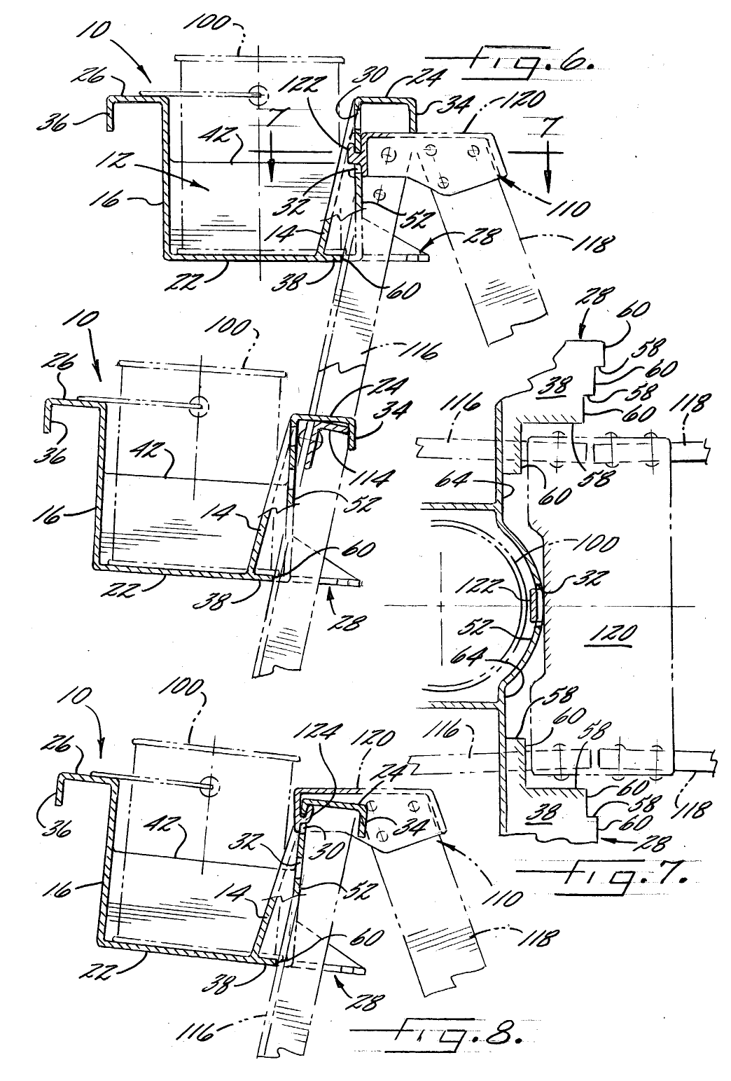

A second opening 32 is also included in a preferred embodiment of the ladder tray 10 as shown in FIG. 2. Second opening 32 is preferably a through hole located on first transverse side 14 proximately below the first opening 30 midway between the longitudinal sides 18 and 20 and is configured to function in a similar fashion as first opening 30. Second opening 32 allows the passage of any protrusion of the ladder and also defines an inner surface for engaging a protrusion of the ladder. FIG. 6 and FIG. 7 illustrate the mounting of a preferred embodiment of the invention onto a ladder 110 with an outwardly projecting paint can holder tab 122. The hook feature 34 of the first support member 24 engages the top platform of a step ladder while the paint can holder tab 122 protrudes through the second opening 32, as illustrated in FIG. 7. The width guide 28 engages the uprights of the ladder to prevent transverse motion of the ladder tray 10 while keeping the ladder tray 10 level relative to the top platform of the ladder. In a preferred embodiment, the top inside surface of the second opening 32 engages the top surface of the paint can holder tab of the ladder to supplement the support provided by the first support member 24. Other embodiments of second opening 32 may simply provide clearance for the paint can holder tab to pass through the first transverse side 14. Further embodiments may incorporate a single opening which functions as both first opening 30 and second opening 32, or may include more than two openings.

The receptacle 12 of the ladder tray 10 is configured to hold a variety of tools, paints, hardware, and the like as shown in FIG. 3. In a preferred embodiment the ladder tray 10 includes a concave cavity 52 in the first transverse side 14, as best illustrated in FIG. 2. The concave cavity 52 constitutes a curved surface of any radius, causing the first transverse side 14 to protrude outward and the bottom surface 22 to extend to the lower end of the first transverse side 14 so that no gaps or holes are present in the interface between the bottom surface 22 and the first transverse side 14. The concave cavity 52 is preferably located in the middle of the first transverse side 14 and dimensioned to allow a one-gallon paint container 100 to be placed in the receptacle 12 of ladder tray 10. In such a preferred embodiment, the first opening 30 and second opening 32 would be defined within the curved surface of the concave cavity 52, as shown in FIG. 2. Other embodiments of the present invention may be located or sized according to the application. Though not illustrated, a similar concave cavity may also be included in the second transverse side 16 in other embodiments of the present invention.

FIG. 6 illustrates two positions for attaching the ladder tray 10 to a step ladder 110. The lower of the two embodiments is similar to FIG. 5 in that the ladder tray 10 is connected to a horizontal bar 114 on the back side of the step ladder 110; however, rather than the second support member 26 engaging the horizontal bar 114, the first support member 24 is resting upon the horizontal bar 114. It should be noted that horizontal bar 112 of FIG. 5 is a flat bar while the horizontal bar 114 of FIG. 6 forms a right angle such that the first support member 24 engages the horizontal bar 114 differently than it would engage the horizontal bar 112 of FIG. 5. If the second support member 26 were used on a horizontal bar 114 of FIG. 6, the ladder tray 10 would be angled with respect to the ground or the steps and top platform 120 of the step ladder 110 because of the contact with the second transverse side 16. However, the angled first transverse side 14 allows contact between the first transverse side 14 or the width guide 28 and the uprights 116 such that the ladder tray 10 is mounted level relative to the ground or top platform 120. In such a manner, the ladder tray 10 can be attached to a variety of horizontal surfaces using either the first support member 24 or second support member 26 so that angular orientation of the ladder tray is optimal for the application the user intends.

As further illustrated in the lower embodiment of FIG. 6, the width guide 28 engages the upright 116. The transverse edge 60 engages surface of the upright 116 facing the ladder tray 10, while a longitudinal edge 58 preferably engages, though longitudinal edge 58 may simply be proximate, a surface of the upright 116 generally perpendicular to the facing surface such that the longitudinal edge 58 prevents or minimizes transverse motion of the ladder tray 10 relative to the ladder 110. The longitudinal edges 58 engage or are proximate both uprights such that motion in both transverse directions is prevented or restricted. In another embodiment the facing surface of the upright 116 may pass through the gap 64 of the width guide 28 such that the upright 116 engages the first transverse side 14 of the ladder tray. In such an embodiment, the longitudinal edge 58 engages or is proximate the surfaces of the upright such that transverse motion is prevented or restricted.

In the upper embodiment of FIG. 6, the ladder tray 10 is mounted to the top platform of step ladder 110. Step ladder 110 includes an outwardly projecting paint can holder tab 122. As also shown in the top view of FIG. 7, outwardly projecting paint can holder tab 122 is a protrusion of the top platform 120 of the step ladder 110. The tab 122 preferably passes through the second opening 32 and a top surface of the second opening 32 engages the top surface of the tab 122 such that support for the ladder tray 10 is provided. Further support is created by the engagement of first hook feature 34 with the upper surface of the top platform 120. As shown in FIG. 7, the second opening 32 preferably provides an orifice slightly larger than the tab 122 such that transverse motion of the ladder tray 10 with respect to the step ladder 110 could be limited. However, transverse motion restriction is provided by the width guide 28. The transverse edges 60 of the width guide 28 engage the surface of the uprights 116 facing the ladder tray 10, while the longitudinal edges 58 engage or are proximate a surfaces of uprights 116 perpendicular to the facing surfaces of the uprights 116. Therefore transverse motion of the ladder tray 10 is prevented or minimized.

FIG. 8 illustrates the mounting of ladder tray 10 to a step ladder 110 that includes an inwardly projecting paint can holder tab 124. The tab 124 is positioned underneath the top platform 120 of the step ladder 110 and faces toward the center of the step ladder 110. The ladder tray 10 is mounted such that the tab 124 is inserted through the first opening 30 and the top inside surface of first opening 30 rests upon the top surface of the protruding tab 124. The tab 124 may also include an upwardly projecting hook that would engage the first transverse side 14 or neck portion 56 of the ladder tray 56 proximate the first opening 30. When the ladder tray is mounted to tab 124 under the top platform 120, the first support member 24 may not engage a surface, wherein the top inside surface of first opening 30 provides the support for ladder tray 10. Width guide 28 engages the uprights 116 of step ladder 110 in a manner similar to the engagements in FIG. 6.

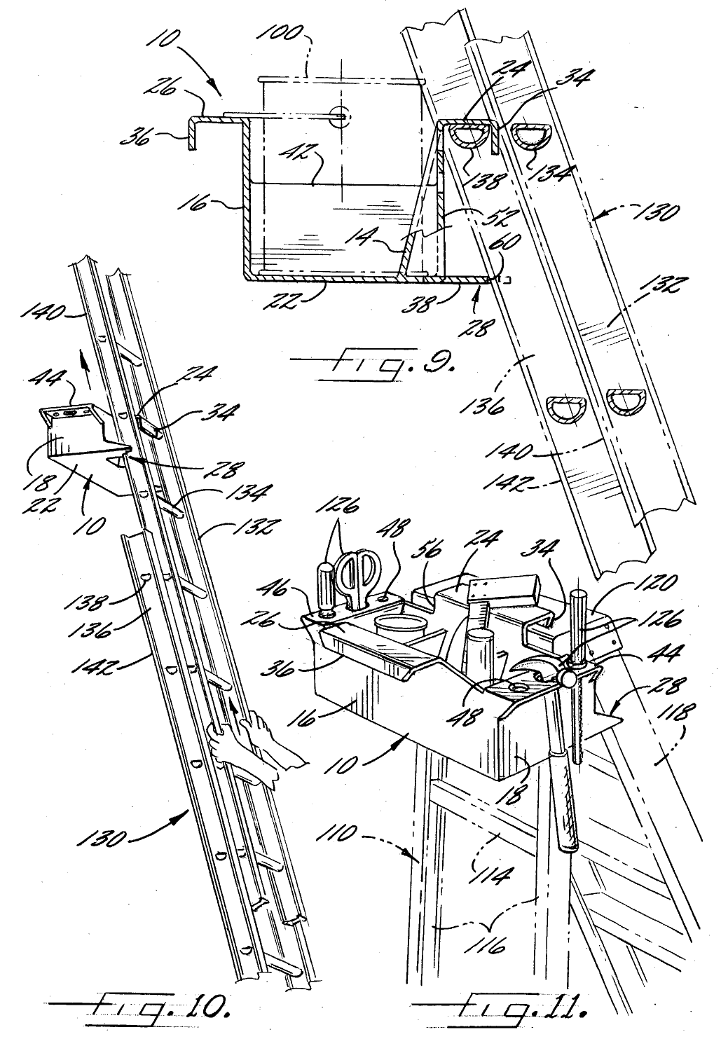

FIG. 9 illustrates the mounting of ladder tray 10 to an extension ladder 130. The extension ladder 130 has an outer portion 132, which is the portion closer to the user prior to extension of the ladder, and an inner portion 136, which is the portion closer to the surface upon which the ladder is supported. Outer portion 132 includes outer rungs 134, and inner portion 136 includes inner rungs 138. FIG. 9 shows the ladder tray 10 mounted to an inner rung 138 of the extension ladder 130. First support member 24 engages the top surface of the inner rung 138 while the first hook feature 34 engages or is proximate an edge of the inner rung 138. The transverse edges 60 of width guide 28 engage the inner upright surface 142 such that the ladder tray 10 is prevented from rotating about inner rung 138, and the longitudinal edges 58 of width guide 28 engage or are proximate the sides of the ladder perpendicular to the inner upright surface 142 so that transverse motion of the ladder tray 10, relative to the extension ladder 130, is prevented or restricted. FIG. 10 illustrates the mounting of ladder tray 10 to the outer portion 132 of the extension ladder when the ladder tray 10 is required to be mounted on a rung above the inner portion 136. The ladder tray 10 is attached to the outer rung 134 and engages the outer upright surface 140 in a similar fashion as it was attached to the inner rung 138 and engaged the inner upright surface 142 in FIG. 9. As shown in FIG. 10, the ladder tray 10 may be mounted to the outer portion 132 of the extension ladder 130 before the ladder is fully extended such that ladder tray 10 remains attached to the extension ladder 130 during extension.

In addition to holding paint containers as shown in FIG. 3, the ladder tray 10 is also intended to hold tools and materials as shown in FIG. 11. The ladder tray 10 is mounted to the top platform 120 of a step ladder 110 in FIG. 11 such that first supporting member 24 engages the top platform 120 while the width guide 28 engages the uprights 116. Tools 126 such as scissors, screwdrivers, and hammers may be inserted in the orifices 48 of flanges 44 and 46. In addition, tools and materials 126 may be placed in the compartments of receptacle 12 of ladder tray 10.

The ladder tray 10 in a preferred embodiment remains in a fixed angular orientation to the ladder to which it is mounted such that the bottom surface 22 of the receptacle 12 remains generally parallel to the horizontal surface of the ladder to which it is mounted. The ladder tray 10 preferably remains level to the ground or surface on which the latter is supported, but if the horizontal surfaces of the ladder, such as the steps or top platform 120 of a step ladder 110 or the rungs 134 and 138 of an extension ladder 130, are angled relative to the ground or the support surface the ladder tray 10 may also be accordingly angled. A non-limiting example would be an extension ladder 130, as in FIG. 9 or 10, that is rested upon a surface such that the rungs are not horizontal, the ladder tray 10 once mounted onto the ladder 130 might also angled. In such a manner, the mounted ladder tray 10 maintains a fixed angular orientation with respect to the ladder 130. The preferred fixed angular orientation is horizontal, though the orientation can depend upon the surface upon which the ladder is supported, the incline of the ladder, the support member utilized, or the surface on which the ladder tray 10 is mounted.

As illustrated in FIGS. 5 through 11, the ladder tray 10 may be conveniently mounted on an assortment of ladders and at various locations on the ladders. The ladder tray 10 of a preferred embodiment does not require any fasteners or the manipulation of adjustable supports to mount it securely. However, other embodiments of the present invention may include adhesives, fasteners, adjustable members, or the like. The ladder tray 10 is configured to project away from the user of the ladder so that the ladder tray 10 does not obstruct the use of the steps above the step or rung or other horizontal surface the ladder tray 10 is mounted. The ladder tray 10 may also be selectively attached to the front or outer surfaces of the ladder so that the ladder tray 10 would face the user and obstruct ascension further up the ladder.

The ladder tray is preferably manufactured using existing plastic molding techniques. However, the ladder tray may also be made with wood, metal, or similar materials. The tray could be produced as a single piece or as multiple pieces that require a small degree of assembly. The tray could also be manufactured in a variety of sizes or shapes. The ladder tray could also be built for a specific purpose such as to accommodate a paint roller or certain plumbing or electrical fittings. The material used to manufacture the ladder tray 10 is preferably robust and rigid such that supporting members 24 and 26 may be stepped on without causing damage to ladder tray or allowing the ladder tray to fall off. In such a manner, the ladder tray 10 conveniently provides the user access to ascend steps or rungs of the ladder above the ladder tray.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A ladder tray for supporting tools or materials on a ladder, comprising:
a receptacle defining a bottom surface, a first transverse side, a second transverse side, a first longitudinal side, and a second longitudinal side, wherein each of the sides extends upward from said bottom surface, wherein said first transverse side extends upward from a lower end connected to said bottom surface and terminates at an upper end of said first transverse side;
said first transverse side including a first support member proximate the upper end of said first transverse side, said first support member extending outward and including a hook feature; and
said first transverse side further including a width guide proximate the lower end of said first transverse side, said width guide extending outward in a direction generally parallel to said first support member;
wherein said width guide is structured and arranged to engage at least one upright of the ladder to restrict transverse motion of the ladder tray.

2. A ladder tray according to claim 1, wherein said width guide includes at least one stepped portion defining at least one transverse edge and at least one longitudinal edge.

3. A ladder tray according to claim 2, wherein said width guide defines at least two stepped portions that define a gap between said at least two stepped portions.

4. A ladder tray according to claim 3, wherein said at least two stepped portions include at least one transverse edge and at least one longitudinal edge on each of said at least two stepped portions, said at least one transverse edge being structured and arranged to engage an upright of the ladder to resist longitudinal motion of the ladder tray and said at least one longitudinal edge being structured and arranged to engage an upright of the ladder to resist transverse motion of the ladder tray.

5. A ladder tray according to claim 4, wherein said gap of said width guide is structured and arranged to allow said first transverse side of said receptacle to engage at least one upright of the ladder to resist longitudinal motion of the ladder tray, wherein said at least one longitudinal edge of said at least two stepped portions engages at least one upright of the ladder to resist transverse motion of the ladder tray.

6. A ladder tray according to claim 3, wherein said width guide is structured and arranged to maintain a fixed angular orientation of the ladder tray while mounted to the ladder.

7. A ladder tray according to claim 1, wherein said width guide includes at least two transverse edges and at least two longitudinal edges, said at least two transverse edges being structured and arranged to engage an upright of the ladder to resist longitudinal motion of the ladder tray and said at least two longitudinal edges being structured and arranged to engage an upright of the ladder to resist transverse motion of the ladder tray.

8. A ladder tray according to claim 1, wherein said upper end of said first transverse side defines at least one opening with a top inside surface, said at least one opening being structured and arranged for receiving a protrusion from the ladder and said top inside surface being structured and arranged for engaging the protrusion to provide support for the ladder tray.

9. A ladder tray according to claim 1, wherein said second transverse side extends upward from a lower end connected to said bottom surface and terminates at an upper end of said second transverse side; and
said second transverse side further including a second support member proximate the upper end of said second transverse side, said second support member extending outward and including a hook feature;
wherein said second support member is structured and arranged such that said width guide of the ladder tray faces away from the ladder upon which the ladder tray is mounted.

10. A ladder tray according to claim 1, wherein said first longitudinal side further includes a first longitudinal flange extending outward and defining at least one orifice for supporting the tools or materials.

11. A ladder tray according to claim 10, wherein said second longitudinal side further includes a second longitudinal flange extending outward and defining at least one orifice for supporting the tools or materials.

12. A ladder tray according to claim 1, wherein said first transverse side defines a concave cavity.

13. A ladder tray according to claim 1, wherein said receptacle includes at least one divider to separate said receptacle into at least two discrete compartments.

14. A ladder tray for supporting tools or materials on a ladder, comprising:
a receptacle defining a bottom surface, a first transverse side, a second transverse side, a first longitudinal side, and a second longitudinal side, wherein each of the sides extends upward from said bottom surface, wherein said first transverse side extends upward from a lower end connected to said bottom surface and terminates at an upper end of said first transverse side;
said first transverse side defining at least one opening through said first transverse side proximate the upper end of said first transverse side; and
said first transverse side further including a width guide proximate the lower end of said first transverse side;
wherein said at least one opening is structured and arranged to receive at least one protrusion of the ladder;
wherein said width guide is structured and arranged to engage at least one upright of the ladder to restrict transverse motion of the ladder tray.

15. A ladder tray according to claim 14, wherein the first transverse side further includes a first support member proximate the upper end of said first transverse side, said first support member extending outward and including a hook feature.

16. A ladder tray according to claim 14, wherein said width guide includes at least one stepped portion defining at least one transverse edge and at least one longitudinal edge, wherein said at least one transverse edge being structured and arranged to engage an upright of the ladder to resist longitudinal motion of the ladder tray and said at least one longitudinal edge being structured and arranged to engage an upright of the ladder to resist transverse motion of the ladder tray.

17. A ladder tray according to claim 14, wherein said width guide defines at least two stepped portions defining at least one longitudinal edge and defining a gap between said at least two stepped portions, said gap being structured and arranged to allow said first transverse side of said receptacle to engage at least one upright of the ladder to resist longitudinal motion of the ladder tray and said at least one longitudinal edge of said at least two stepped portions engages at least one upright of the ladder to resist transverse motion of the ladder tray.

18. A ladder tray according to claim 17, wherein said second transverse side extends upward from a lower end connected to said bottom surface and terminates at an upper end of said second transverse side; and
said second transverse side including a second support member proximate the upper end of said second transverse side, said second support member extending outward and including a hook feature;
wherein said second support member is structured and arranged such that said width guide of the ladder tray faces away from the ladder upon which the ladder tray is mounted.

19. A ladder tray for supporting tools or materials on a ladder, comprising:
a receptacle defining a bottom surface, a first transverse side, a second transverse side, a first longitudinal side, and a second longitudinal side, wherein each of the sides extends upward from said bottom surface, wherein said first transverse side extends upward from a lower end connected to said bottom surface and terminates at an upper end of said first transverse side, wherein said second transverse side extends upward from a lower end connected to said bottom surface and terminates at an upper end of said second transverse side;
said first transverse side including a first support member proximate the upper end of said first transverse side, said first support member extending outward and including a hook feature;
said second transverse side including a second support member proximate the upper end of said second transverse side, said second support member extending outward and including a hook feature;
said first transverse side defining at least one opening through said first transverse side proximate the upper end of said first transverse side; and
said first transverse side further including a width guide proximate the lower end of said first transverse side, said width guide extending outward in a direction generally parallel to said first support member;
wherein said at least one opening is structured and arranged to receive at least one protrusion of the ladder;
wherein said width guide includes at least one stepped portion defining at least one transverse edge and at least one longitudinal edge, said at least one transverse edge being structured and arranged to engage an upright of the ladder to resist longitudinal motion of the ladder tray and said at least one longitudinal edge being structured and arranged to engage an upright of the ladder to resist transverse motion of the ladder tray.
